(19) United States
(12) Patent Application Publication
(10) Pub. No.: US 2012/0115118 A1
(43) Pub. Date: May 10, 2012

(54) SUTURE TRAINING DEVICE

(76) Inventor: M. Blair Marshall, McLean, VA (US)

(21) Appl. No.: 12/941,477

(22) Filed: Nov. 8, 2010

(51) Int. Cl. G09B 23/28

(52) U.S. Cl. 434/262

(57) ABSTRACT

A suture training device includes a lower surface to be positioned on a support and a periphery having a three dimensional surface geometry including a plurality of visible indicia thereon for visually identifying locations into which a suturing needle is to be inserted. Preferably the plurality of visible indicia includes a group of indicia surrounding a peripheral opening extending through said periphery.

### BACKGROUND OF THE INVENTION

This invention relates generally to a device for teaching surgical skills, and more particularly for teaching or training a surgical trainee in proper suturing techniques. Reference throughout this application to a “surgical trainee” includes surgeons, medical students, residents, fellows and any other medical personnel having a need or desire to acquire or maintain expertise in suturing techniques.

It is important for a surgical trainee to acquire and maintain expertise in suturing techniques in connection with performing or assisting in operations and other medical procedures,

On approach that has been employed to teach or train a surgical trainee to carry out proper operating techniques, including proper suturing techniques, has been to form synthetic chests out of plastic and other suitable material and to incorporate into the synthetic chest cow or pig heart-lung blocks from a slaughter house to thereby allow a surgical trainee to carry out operating procedures in a simulated environment. Although this is a useful technique for teaching and training purposes, it is significant limitations. For example, the animal parts have a limited shelf life, thereby limiting the period of use of these models and requiring the frequent replacement of animal parts. In addition, this technique for teaching surgical procedures is not cost effective since it requires substantial time of a professor to provide the teaching function. Moreover, the above synthetic chest models can only be employed in a fixed location, such as in a laboratory of a medical school or other hospital facility. In other words, these models are not portable and therefore do not provide a vehicle for a surgical trainee to gain experience in providing an anastomosis outside of a hospital, or medical school setting, such as at the trainees place of residence.

The prior art also teaches the use of a variety of other artificial devices for aiding in teaching or training surgical procedures, such as suturing, to a surgical trainee. Exemplary teachings are included in U.S. Pat. Nos. 4,321,047 (Landis); 3,775,865 (Rowan); 6,997,719 (Wellman et al.); 5,320,537 (Watson) and 4,789,340 (Zilria). However, none of the prior art devices known to applicant provide the desired versatility in teaching a surgical trainee to employ proper suturing techniques in difficult environments, e.g., when a vessel or valve to be sutured is in a difficult to engage location within a patient's body.

In view of the above-described deficiencies, it has been determined that a need exists to provide portable teaching aids that do not employ animal parts; that simulate difficult to reach locations in which a suturing operation often is required to be carried out, and that is sufficiently mobile or portable to permit a surgical trainee to practice his/her surgical skills in any convenient location, such as a hospital, medical school, the surgical trainees' residence, etc. It is to such a suture training device that the present invention is directed.

### BRIEF SUMMARY OF THE INVENTION

A suture training device for teaching or training a surgical trainee to provide correct three dimension suture technique includes a lower surface adapted to be positioned on a support and a periphery having a three dimensional surface geometry including a plurality of visible indicia thereon for visually identifying locations and three dimensional angles into which a suturing needle is to be inserted.

In a preferred embodiment the plurality of visual indicia are arranged in one or more groups, each group providing a sewing ring surrounding a peripheral opening extending through the periphery.

In a preferred embodiment the plurality of visible indicia are included in at least two groups, with each group providing a sewing ring surrounding a respective peripheral opening extending through the periphery and with at least two of the respective peripheral openings being 3-dimensionally spaced from each other.

In a most preferred embodiment of the invention, the respective groups of indicia are in the form of spaced apart, visible dots defining a predetermined configuration, and most preferably the predetermined configuration of each group of dots is provided in a peripheral region adjacent the marginal edge of a respective opening through the periphery.

In the most preferred embodiment of the invention the periphery of the suture training device includes at least two passages, or openings, therein with peripheral regions contiguous to each opening constituting an entry region about which a suturing operation is to be carried out, and each opening includes a central axis with the central axes of at least two of the openings crossing each other at an acute angle.

In the most preferred embodiment of the invention the three dimensional surface geometry is substantially hemispherical, including a curved upper, or apex region and a curved peripheral side.

In the preferred embodiment wherein the periphery is in the form of a substantially hemispherical shape at least one opening is provided substantially in the apex region of the hemisphere and at least a second opening is provided in the curved peripheral side below said apex region.

In the preferred embodiment wherein the periphery is in the form of a substantially hemispherical shape, at least to openings in said periphery having central axis that cross each other at an acute angle.

In accordance with another aspect of the invention the visible indicia, or dots, can be eliminated from the device as a surgical trainee becomes more proficient in the suturing technique.

Other objects and advantages of this invention will become apparent upon considering the detailed description which follows, when taken in conjunction with the following drawings wherein:

### BRIEF DESCRIPTION OF SEVERAL VIEWS OF THE DRAWINGS

FIG. 1 is an isometric view of a suture training device in accordance with this invention; and

FIG. 2 is an isometric view of the suture training device of FIG. 1 retained within an interior compartment of a housing that simulates the chest cavity of a patient to be operated upon.

### DETAILED DESCRIPTION OF THE PREFERRED EMBODIMENTS

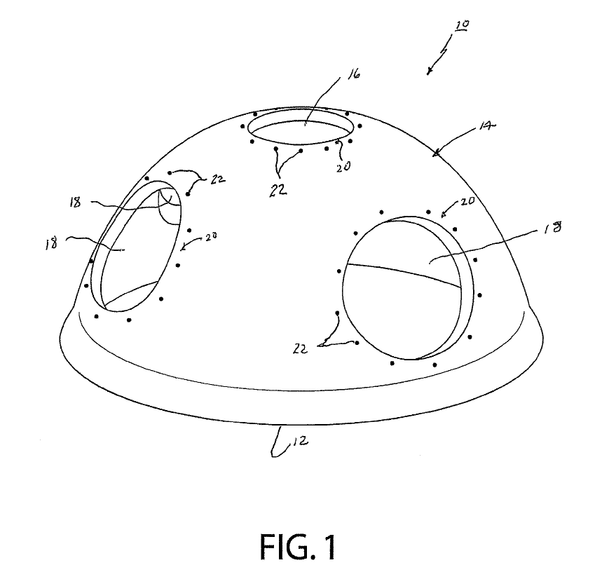

Referring to FIG. 1 a suture training device in accordance with this invention is indicated at 10. The training device 10 includes a lower surface 12 to be positioned on a support and a periphery 14 having a 3-dimensional surface geometry, preferably in the general configuration of a hemisphere.

It should be understood that other 3-dimensional surface geometries can be employed, e.g., trapezoidal, square, etc. within the broadest aspect of this invention. However, the hemispherical periphery 14 illustrated in FIG. 1 is a preferred construction for establishing, or providing, desired angles in sections to be sutured.

Still referring to FIG. 1, the suture training device 10 is illustrated as including a passage 16 at the apex of the hemisphere and a plurality of passages 18 spaced about the peripheral side of the hemisphere below the apex.

In the illustrated embodiment the plurality of passages 18 are circumferentially, equally spaced at ninety degree intervals about the peripheral side of the hemisphere, thereby providing four (4) passages 18.

Still referring to FIG. 1, at least two of the passages, e.g., adjacent passages 18 in the peripheral side of the hemisphere, include central axis that cross each other at an acute angle. In addition, the central axis of the passages 18 form an acute angle with a supporting surface, when the lower surface 12 of the suture training device 10 is positioned on the supporting surface.

It should be understood that the number of openings provided in the periphery 14, as well as the configuration and/or dimension of the openings can be varied within wide limits. For example, the size and configuration of the openings 16, 18 can be varied to be different from each other. However, in the preferred embodiment of this invention the openings 16, 18 are substantially round, thereby providing suturing aid to instruct a surgical trainee in the proper surgical technique for providing an anastomosis involving a valve, such as the aortic valve.

Still referring to FIG. 1, each of the openings 16, 18 includes a peripheral region 20 contiguous to the marginal edges of the openings and each of these peripheral regions includes spaced apart visible indicia 22 thereon. These visual indicia 22 are arranged in the peripheral regions 20 about each of the openings 16, 18 and are in the form of dots, which can be provided by an ink stamp. Preferably, and as illustrated in the drawings, the dots 22 have a predetermined configuration substantially the same as the configuration of the openings 16, 18.

In the illustrated embodiment the visual indicia, or dots, 22 are arranged in the form of circles, or rings in the peripheral regions 20 of the openings 16 and 18 to identify the locations through which a suturing needle should be inserted by a driver to provide a correct anastomosis. In other words, the arrangement of dots 22 creates a visual indication of the proper location in which the sutures should be inserted.

In accordance with the broadest aspect of this invention, the surgical training device 10 can be made from many desired material that can be penetrated by a suture needle with a force that substantially simulates the force encountered during a surgical procedure. In a preferred construction the material employed to form the surgical training device 10 can be a rubber-based material or an elastomeric material. The specific material employed to form the surgical training device 10 does not constitute a limitation on the broadest aspects of this invention and can easily be selected by those skilled in the art.

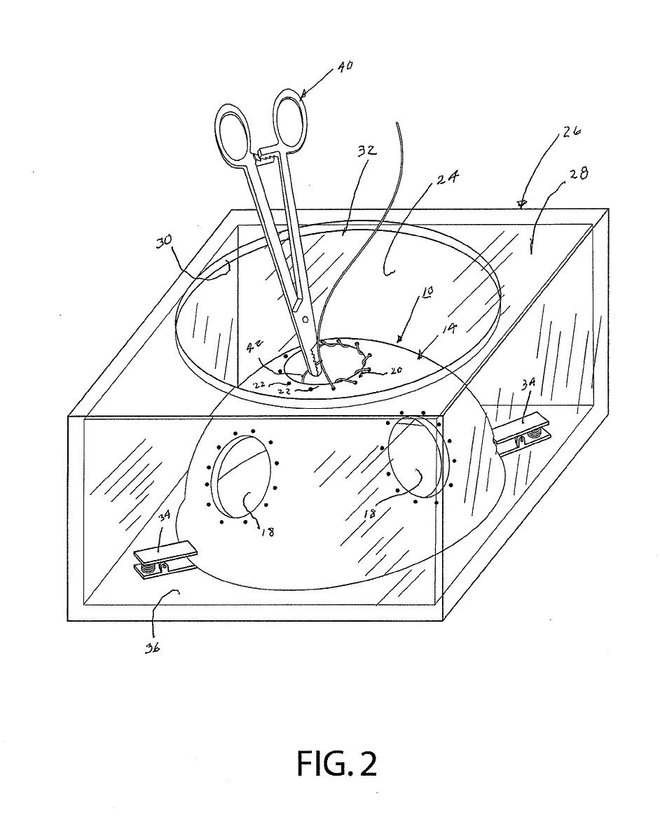

Referring to FIG. 2, the suture training device 10 is shown as being retained within a 3-dimensional compartment 24 of a housing 26. Most preferably the housing 26 is made of a clear plastic to thereby permit the surgical trainee to visually see or observe the areas to be sutured in the suture training device 10, much in the same way that a surgeon is able to view the situs to be sutured during an operation.

The housing 26 can be made of any desired material, such as, for example, polyethylene terephthalate (PET). However, it should be understood that the particular material used to form the housing 26 does not constitute a limitation on the broadest aspects of this invention.

Moreover, in accordance with the broadest aspects of this invention, the housing 26 can be made either translucent or even opaque, and a separate light source can be included within the interior compartment 24 to render the suture training device 10 visible to a surgical trainee.

Still referring to FIG. 2, upper wall 28 of the housing 26 includes a peripheral edge 30 defining a passage 32 communicating with the interior compartment 24. This passage 32 simulates the opening provided in the chest of a patient during a surgical procedure.

It should be understood that the passage 32 can be made of varying sizes, to thereby either increase or decrease the difficulty of the suturing for training a surgical trainee in providing a proper anastomosis.

Moreover, the size and/or configuration of the housing 26 can be varied within the scope of the invention. For example, the housing 26 can be provided in varying heights, to thereby vary the position, or distance, between the passage 32 through the upper wall 28 of the housing 26 and the periphery 14 of the suture training device, to thereby vary the difficulty in providing a proper anastomosis.

It also should be understood that the upper wall 28 can be in the form of a hinged lid (not shown), to thereby permit the housing 26 to be opened for receiving the suture training device 10 therein.

Still referring to FIG. 2, in order to immobilize the surgical training device 10 within the compartment 24 of the housing 26 a pair of clips 34 are secured to lower wall 36 of the housing (or a lower wall of a separate support positioned on lower wall 36 of the housing). The gripping, or free ends of the clips 34 are spring-biased into a closed position to engage a lower peripheral edge of the surgical training device 10 in diametrically opposed areas.

Of course, in accordance with the broadest aspects of this invention the surgical training device 10 can be immobilized by any desired means. For example, it may be possible to actually provide a lower, horizontally extending segment on the surgical training device configured to engage the peripheral sidewalls of the housing 26 to thereby immobilize the surgical training device 10 within the housing 26.

In other words, the particular mechanism or structure employed to immobilize the surgical training device 10 during use of the device does not constitute limitation on the broadest aspects of this invention.

Still referring to FIG. 2, a driver 40 of conventional design is employed for gripping a suturing needle 42 and directing the needle through a peripheral region 20; preferably through a visible dot 22 included in that region. The prior, proper placement of stitches through dots 22 in the peripheral region 20 surrounding the opening 16 also is illustrated in FIG. 2.

It should be understood that providing a plurality of openings 18 (e.g., 4) circumferentially spaced about the peripheral side of the periphery 14 requires the surgical trainee to manipulate the driver 40 in different orientations, to provide proper stitching about the respective openings. In some cases, the surgical trainee may be required to use a backhand insertion procedure, which often needs to be used in an actual surgical procedure to provide a proper anastomosis.

The provision of opening 16 and 18 in different 3-dimensional planes and locations in the periphery 14 of the training device 10 provides significant training versatility in establishing a proper anastomosis at varying suturing angles, similar to what is encountered when providing an anastomosis in an actual surgical procedure.

Although the most preferred embodiment of this invention includes a group of visible indicia 22 spaced about the peripheral region 20 of each of the opening 16 and 18, it is within the scope of the broadest aspect of this invention to simply provide groups of visible indicia of a predetermined configuration spaced about the three-dimensional periphery 14, but without the inclusion of openings through the periphery. For example, the various groups of visible indicia illustrated in FIGS. 1 and 2 could be employed in a surgical training device in the exact same locations as illustrated in FIGS. 1 and 2, but without surrounding openings extending through the periphery 14. This is a less preferred embodiment since the suturing operation would need to be carried out about the periphery of the dots without extending into or through any opening, such as openings 16 and 18 employed in the preferred embodiments of this invention.

While this invention has been described in detail with reference to specific examples thereof, it would be apparent to those skilled in the art that various changes and modifications can be made therein without departing from the spirit and scope thereof.

What I claim as my invention is:

1. A suture training device for enhancing three dimensional suturing skill, said suture training device including a lower surface adapted to be positioned on a support and an upper periphery having a three dimensional surface geometry including a plurality of visible indicia thereon for visually identifying locations and three dimensional angles into which a suturing needle is to be inserted.

2. The suture training device of claim 1, wherein said plurality of visible indicia includes a group of said indicia surrounding a peripheral opening extending through said periphery.

3. The suture training device of claim 1, wherein said plurality of visible indicia includes at least two groups of indicia, each group surrounding a respective peripheral opening extending through said periphery, at least two of said respective peripheral openings being three-dimensionally spaced from each other.

4. A suture training device of claim 1, wherein said plurality of visible indicia includes a group of said indicia arranged in a predetermined configuration.

5. The suture training device of claim 4, wherein said plurality of visible indicia includes at least two groups of indicia, each group being arranged in a predetermined configuration, at least two of said groups of indicia being three-dimensionally spaced from each other.

6. A suture training device for establishing an anastomosis, said suture training device including a lower surface adapted to be positioned on a support and an upper periphery having a three dimensional surface geometry, at least one opening is said periphery providing a peripheral region in which a proper suturing operation is to be carried out.

7. The suture training device of claim 6, wherein said at least one opening includes a central axis disposed at an acute angle to the support when said lower surface of said training device is positioned on said support.

8. The suture training device of claim 6 including at least two openings in said periphery and a peripheral region about each opening in which a proper suturing operation is to be carried out.

9. The suture training device of claim 6 including at least two openings in said periphery, a peripheral region about said at least two openings in which a proper suturing operation is to be carried out, each opening including a central axis, the central axis of two of said openings crossing each other at an acute angle.

10. The suture training device of claim 1, wherein said three dimensional surface geometry is substantially a hemisphere including an apex and a curved peripheral side.

11. The suture training device of claim 10 wherein said plurality of visible indicia includes at least two groups of indicia, each group being arranged in a predetermined configuration, one of said groups of indicia being located substantially at said apex and a second of said groups of indicia being located substantially in said curved peripheral side.

12. The suture training device of claim 11, wherein each of said at least two groups of indicia are in a peripheral region surrounding a respective opening through said periphery.

13. The suture training device of claim 6, wherein said three dimensional surface geometry is substantially a hemisphere including an apex and a curved peripheral side.

14. The suture training device of claim 13, wherein said at least one opening is in said curved peripheral side and includes a central axis disposed at an acute angle to the support when said lower surface of said training device is positioned on said support.

15. The suture training device of claim 13 including at least two openings, a first of said at least two openings being substantially at said apex and a second of said at least two openings being substantially in said curved peripheral side and a peripheral region about said first and second openings in which a proper suturing operation is to be carried out.

16. The suture training device of claim of claim 14 wherein said first and second openings each include a central axis, the central axis of said first and second openings crossing each other at an acute angle.

17. The suture training device of claim 1 being retained in a three dimensional compartment of a housing, said housing including a peripheral wall with a passage therethrough for providing access to the suture training device from a location outside of said compartment.

18. The combination of claim 17, said housing including clear peripheral walls providing visibility of the training device therein.

19. The suture training device of claim 6 being retained in a three dimensional compartment of a housing, said housing including a peripheral wall with a passage therethrough for providing access to the suture training device from a location outside of said compartment.

20. The combination of claim 19, said housing including clear peripheral walls providing visibility of the training device therein.
